(19) United States
(12) Patent Application Publication
(10) Pub. No.: US 2026/0358810 A1
(43) Pub. Date: Nov. 12, 2026

(54) METHOD FOR DIRECT MID-AIR COAXIAL HELICOPTER DELIVERY

(71) Applicant: California Institute of Technology, Pasadena, CA (US)

(72) Inventor: Havard F. Grip, La Crescenta, CA (US)

(73) Assignee: California Institute of Technology, Pasadena, CA (US)

(21) Appl. No.: 19/673,810

(22) Filed: May 11, 2026

Related U.S. Application Data
(60) Provisional application No. 63/804,311, filed on May 12, 2025.

(51) Int. Cl. G05D 1/495; B64C 27/10; B64C 27/57; B64C 27/80; B64D 17/80; B64G 1/16; B64U 10/17; B64U 30/24; B64U 70/40; B64U 101/75; G05D 109/25

(52) U.S. Cl. CPC G05D 1/495; B64C 27/10; B64C 27/57; B64C 27/80; B64D 17/80; B64G 1/16; B64U 10/17; B64U 30/24; B64U 70/40; B64U 2101/75; B64U 2201/10; G05D 2109/25

(57) ABSTRACT

A method and system provide for direct mid-air coaxial helicopter delivery. One or more coaxial helicopters are mounted to a fixture attached to a descending parachute. The helicopters have two rotors mounted coaxially that are independently actuated. The rotors are spun up to a constant operating speed. The helicopters are then released from the fixture. After the releasing, the helicopters are controlled using a feedback loop. Roll and pitch are controlled by feeding back a roll and pitch angle error to a combination of collective and cyclic blade pitch controls to produce roll and pitch torques. Heading is controlled by feeding back yaw angle error to a combined motor torque of the two rotors. A rotor speed is controlled by feeding back a scalar combination of rotor speed errors to a differential motor torque of the two rotors.

### CROSS-REFERENCE TO RELATED APPLICATIONS

This application claims the benefit under 35 U.S.C. Section 119 (e) of the following co-pending and commonly-assigned U.S. provisional patent application(s), which is/are incorporated by reference herein:

Provisional Application Ser. No. 63/804,311, filed on May 12, 2025, with inventor(s) Havard F. Grip, entitled “Method for Direct Mid-Air Coaxial Helicopter Delivery,” attorneys' docket number 176.0268USU1.

### STATEMENT REGARDING FEDERALLY SPONSORED RESEARCH AND DEVELOPMENT

This invention was made with government support under Grant No. 80NM0018D0004 awarded by NASA (JPL). The government has certain rights in the invention.

### BACKGROUND OF THE INVENTION

### 1. Field of the Invention

The present invention relates generally to coaxial helicopters, and in particular, to a method, apparatus, system, and article of manufacture for delivering one or more coaxial helicopters to a planetary surface via direct mid-air deployment.

### 2. Description of the Related Art

(Note: This application references a number of different publications as indicated throughout the specification by reference numbers enclosed in brackets, e.g., [x]. A list of these different publications ordered according to these reference numbers can be found below in the section entitled “References.” Each of these publications is incorporated by reference herein.)

Delivering a vehicle to the Martian surface involves a complex sequence of steps that has traditionally included supersonic atmospheric entry inside an aeroshell, deceleration on a supersonic parachute, and use of retrorockets for final deceleration before landing on the surface. This sequence is known as entry, descent, and landing (EDL). The landing portion of EDL is complex and cost-driving, as it must ensure a sufficiently soft contact with (and safe settling on) the surface, and this must take place in sufficiently benign terrain for the landing event itself and subesequent operations.

Mars Helicopters, like the Ingenuity technology demonstrator [1], are inherently capable of flying and landing repeatedly on the surface under their own power. For this reason, concepts have been developed for deploying helicopters in mid-air, either with a direct release from the parachute [2] or using an intermediate, rocket-powered “jetpack” to slow the helicopter descent rate [3]. Up to now, these studies have not demonstrated feasibility of the direct release with realistic modeling, nor have they developed a functional guidance and control scheme for executing the necessary flight profiles. Rather, using simple modeling tools combined with experiments, they have highlighted significant challenges associated with this approach and concluded that a jetpack approach is a safer choice.

The planned rotorcraft mission Dragonfly to Saturn's moon Titan [4] will perform a direct release of the rotorcraft from a parachute during the descent phase. However, with a 400-1 advantage in atmospheric density, a 3-1 advantage in gravity, and wind magnitudes that are a fraction of Martian winds, the problem looks dramatically different. In particular, the rotorcraft will separate at around 7.5% of the velocities considered for Mars mid-air delivery [see 5], and due to the low release velocity and favorable aerodynamic conditions, concerns about Mach number violations become moot. Finally, the Dragonfly lander features multiple horizontally displaced rotors, rather than the coaxial design of Ingenuity. This eliminates a central control problem that is addressed by methods of embodiments of the invention.

### SUMMARY OF THE INVENTION

Embodiments of the invention provide a method for delivering one or more coaxial helicopters to a planetary surface (e.g., Mars) via direct mid-air deployment, in which the helicopters are released from a parachute and fly away under their own power. The method specifies a particular flight profile that avoids hazardous flight regimes, as well as the guidance and control required to execute this flight profile. In particular, the method provides a solution to the challenging problem of transitioning from autorotating flight with negative power to regular powered flight while maintaining positive directional control of the aircraft.

### BRIEF DESCRIPTION OF THE DRAWINGS

Referring now to the drawings in which like reference numbers represent corresponding parts throughout:

FIG. 1 illustrates an exemplary coaxial helicopter that may be utilized in accordance with one or more embodiments of the invention;

FIG. 2 illustrates an exemplary configuration of an aerial delivery system for multiple coaxial helicopters in accordance with one or more embodiments of the invention;

FIG. 3 shows the trajectory that would result from a perfect execution of the flight profile in accordance with one or more embodiments of the invention;

FIG. 4 shows the pitch angle as a function of time in accordance with one or more embodiments of the invention;

FIG. 5 shows the horizontal vs. vertical velocity in the body-fixed frame in accordance with one or more embodiments of the invention;

FIG. 6 shows the advancing tip Mach number throughout the flight profile in accordance with one or more embodiments of the invention;

FIG. 7 shows a simulated trajectory in accordance with one or more embodiments of the invention;

FIG. 8 illustrates simulated horizontal vs. vertical velocity in accordance with one or more embodiments of the invention;

FIG. 9 illustrates simulated attitude in accordance with one or more embodiments of the invention;

FIG. 10 illustrates simulated collective and cyclic control inputs in accordance with one or more embodiments of the invention;

FIG. 11 illustrates the simulated result of turning off differential RPM control in accordance with one or more embodiments of the invention;

FIG. 12 illustrates the simulated Mach number at the advancing tip in accordance with one or more embodiments of the invention; and

FIG. 13 illustrates the logical flow for direct mid-air coaxial helicopter delivery in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

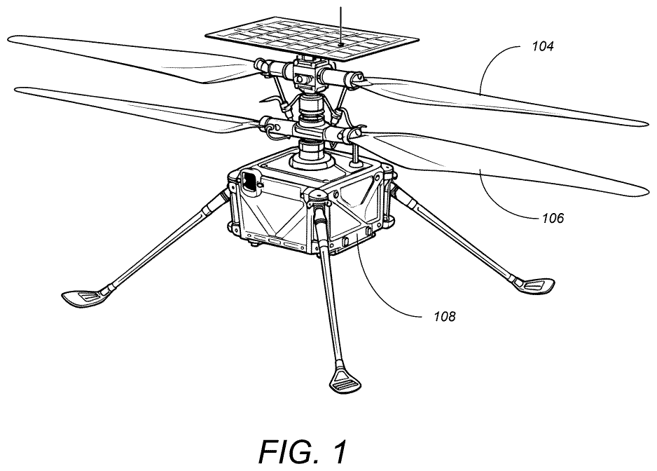

Embodiments of the invention provide a method for aerial delivery of coaxial helicopters (e.g., on Mars) (also referred to herein as Skyfall). FIG. 1 illustrates an exemplary coaxial helicopter 102 that may be utilized in accordance with one or more embodiments of the invention. Such a helicopter 102 has coaxially mounted rotors 104-106, that may be controlled by a rotor mechanism, and includes a control system (within the structure 108). In one or more embodiments, the control algorithms may be implemented on a computer within the structure 108. The control system also encompasses the actuators, mechanisms, linkages etc. that effect changes in motor torque and blade pitch.

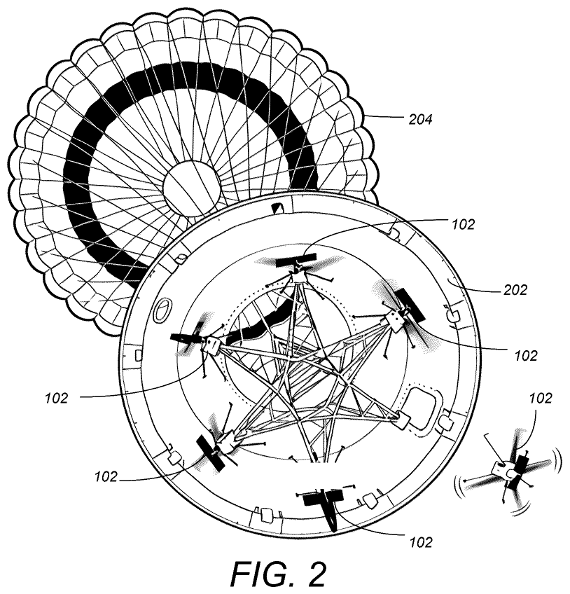

FIG. 2 illustrates an exemplary configuration of an aerial delivery system for multiple coaxial helicopters 102 in accordance with one or more embodiments of the invention. Embodiments of the invention involve helicopter deployment directly from a backshell 202 attached to a parachute 204, prior to helicopter 102 flyaway. This eliminates major cost-driving elements and sources of complexity, and provides additional volume inside the aeroshell 202 to fit one or more helicopters 102. It is envisioned that this delivery system can be used to deploy as many as 6 Ingenuity-class helicopters 102 simultaneously.

As used herein, embodiments of the invention provide for a Skyfall flight profile. The Skyfall flight profile is designed to avoid two potentially hazardous conditions: (i) vortex ring state, in which the helicopter descends into its own wake; and (ii) Mach number violations at the advancing blade tips. In this regard, the flight profile maintains a constant ratio of horizontal to vertical velocities, in the same way as the Vortex ring state avoidance trajectory shown in FIG. 10 of reference [2]. However, reference [2] did not develop a concrete flight profile that would maintain such a velocity ratio, consider the role of Mach number limits, nor attempt to develop the guidance and control associated with it.

Embodiments of the invention further provide for a guidance and control scheme. The guidance and control scheme described herein differs from the classical control techniques used for Ingenuity due to a specific challenge of maintaining yaw control for a coaxial helicopter while executing the Skyfall flight profile. This solution is enabling for the entire concept and represents a novel innovation.

In addition, embodiments of the invention provide for physics-based simulations. The Skyfall concept may be demonstrated in DARTS-HeliCAT, which is the physics based simulation used throughout development, testing, and operations of the Ingenuity helicopter [6].

### Nomenclature

Two frames of reference are defined:
A North-East-Down frame n, with origin on the surface below the helicopter release point, with x axis pointed North, y axis pointed East, and z axis pointed down; and
A body-fixed frame b, with origin at the helicopter center of mass, with x axis pointed forward, y axis pointed left, and z axis pointed down.

The attitude of the b frame with respect to the n frame is defined via the following sequence of rotations from n to b: (i) a yaw angle ψ about the z axis; (ii) a pitch angle θ about the y axis; and (iii) and roll angle φ about the x axis.

The velocity of the helicopter center of mass relative to an inertial frame is denoted by v, with a superscript indicating the frame of reference if applicable. A subscript x, y, or z is used to indicate a scalar component of the velocity vector. The air-relative velocity of the helicopter is similarly denoted by W.

### Assumptions

It is assumed that the helicopters in question have a coaxial rotor configuration, with two vertically displaced counter-rotating rotors on a common mast. Both rotors are equipped with collective pitch control and at least one rotor is equipped with cyclic pitch control. It is furthermore assumed that the rotors are controlled via two motors that allow the application of independent torques on each rotor.

In the following, the term combined collective refers to the sum of the two collective controls, and the term differential collective refers to the difference between the two collectives (upper minus lower or lower minus upper). Similarly, the term combined motor torque refers to the sum of the two motor torques, and the term differential motor torque refers to the difference between the motor torques. For both rotors, the sign of the motor torque is defined to drive the motor in a positive direction relative to the body z axis (clockwise when viewed from above).

The term rotor speed is used to refer to the angular rate of rotation of a rotor with respect to the helicopter body, with positive rotor speed defined as the rotor's nominal direction of rotation. Therefore, both rotors will be operating at positive rotor speed. Differential rotor speed refers to the difference between the two rotor speeds, which should nominally be zero.

It is assumed that the helicopter is equipped with a navigation system that provides estimates of the current attitude and velocity v.

### Helicopter Delivery Method

The helicopter (i.e., Skyfall) delivery method is based around the execution of a flight profile that avoids two hazardous regimes for the helicopter:
Vortex ring state is a condition in which the helicopter descends into its own wake and that wake is recirculated back into the rotor. This will tend to result in a partial loss of thrust, instabilities in the flight dynamics, and unsteady flight conditions (see, e.g., [7]).
Mach number violations In forward flight, the advancing tips of the rotor blades experience the highest air-relative velocities. If these velocities approach the speed of sound, so-called drag divergence will occur, in which drag forces increase dramatically, possibly exceeding what the propulsion motors can handle.

The method of control during this flight profile is designed to avoid instability as a result of an inherent loss of control authority, which results from the transition between initial flight at negative power and eventual flight at positive power.

### Method Summary

The following is a summary of the delivery method, with details covered in subsequent sections.
(1) One or more coaxial helicopters 102 are mounted to a fixture 202 attached to a descending parachute 204, with adequate clearance to obstacles for rotor spinup and release. The helicopters 102 are mounted in a nose-down orientation, as close as practicable to the target pitch angle for initial flight, denoted

$${θ}_{t}^{0} .$$

The target pitch angle

$${θ}_{t}^{0}$$

is chosen such that:
   (a) For any scalar a, a body-fixed air-relative velocity of

$${w}^{b} = a [ - sin ( {θ}_{t}^{0} ) , 0 , cos ( {θ}_{t}^{0} ) ]$$

is outside the region for which the helicopter is at risk of encountering vortex ring state.
(b) If controlled according to the rules enumerated under bullet point (4), the helicopter avoids violating Mach number limits at the advancing tips. This can be determined in the design phase by a simple numerical integration of the helicopter state along with applicable bounds on local wind variations.
(2) Prior to release, the rotors are spun up to a constant operating speed that is a function of the rotor geometry, the atmospheric density, and the vehicle weight.
(3) At a pre-determined target altitude above ground, each helicopter is released, with the release mechanism imparting a non-negative velocity on the helicopter in the direction of the helicopter mast (negative body z direction).
(4) After release, the helicopter is controlled according to the following rules:
   (a) Thrust near maximum capability, typically at least 20% above vehicle weight.
   (b) Roll angle controlled to zero degrees.
   (c) Pitch angle controlled to the target

$${θ}_{t} = {θ}_{t}^{0} + 90 ° - arctan 2 ( {v}_{z} , {\tilde{v}}_{x} ) ,$$

where \tilde{v}ₓ represents the x component of the difference between the helicopter's current velocity and the velocity at the time of release. As an alternative, pitch angle can be controlled to a time-dependent target pitch angle θₜ(t) that was determined based on an offline simulation of the maneuver under nominal conditions.
(d) Heading (yaw angle) controlled to a fixed target aligned with the initial release heading.
(e) Average rotor speed controlled to a chosen target rotor speed.
(f) Differential rotor speed controlled to zero.
(g) No explicit velocity or position control.

Control is achieved through the following feedback loops, each with an appropriate controller (typically a proportional-integral-derivative (PID)-type controller with additional loop shaping):
(a) Thrust controlled by feeding back vertical acceleration error (desired minus actual) to the appropriate combination of collective and cyclic to produce a change in thrust (typically dominated by combined collective).
(b) Roll and pitch controlled by feeding back roll/pitch angle error to the appropriate combination of collective and cyclic to produce roll/pitch torques (typically dominated by cyclic).
(c) Heading controlled by feeding back yaw angle error to combined motor torque.
(d) Average rotor speed controlled by feeding back average rotor speed error to differential motor torque.
(e) Differential rotor speed controlled by feeding back differential rotor speed to differential collective.
(5) At a pre-determined time during the flight profile, control of the differential rotor speed is disabled. This must occur prior to the loss of control authority in that channel resulting from the transition from flight with negative power to flight with positive power (see section description below for details).
(6) After another pre-determined interval, control of the differential rotor speed is re-enabled with a different set of controller gains. This must occur after control authority in that channel is re-established.
(7) Once the helicopter reaches a state of near-zero vertical velocity, control is transitioned to classical control similar to that of the Ingenuity helicopter.

Although the helicopter's translational velocity and position is not explicitly controlled during execution of the flight profile, the helicopter's initial downward trajectory will bend upward as a result of the velocity-relative attitude and the applied thrust. The velocity will gradually decrease, and the helicopter will eventually arrive near hover.

### Example Flight Profile for Specific Scenario

In this section, the flight profile is developed for a specific scenario under the assumption of perfect control. The scenario is as follows:
Arrival at 9 am local true solar time at solar longitude Lₛ=130 at Arcadia Planitia on Mars.
Release from parachute at 1470 m above ground level, where the estimated atmospheric density is 0.0155 kg/m³ and the temperature −55 °C. The resulting speed of sound in CO₂ is 232 m/s.
Mars 2020-style parachute with a total mass on chute of 700 kg, resulting in a vertical release velocity of 39 m/s.

The helicopter is assumed to be consistent with the design of the Sample Recovery Helicopter (SRH) [8], with an assumed mass of 2.5 kg, a rotor diameter of 70.65 cm and a thrust-weighted solidity of σ=0.125188. Consistent with SRH experimental results, tip Mach numbers up to 0.95 are considered acceptable. It is furthermore assumed that the vehicle is capable of thrusting at a level consistent with a hover C_{T}/σ=0.142, where C_{T} is the thrust coefficient, defined as the ratio of thrust to atmospheric density, tip speed squared, and rotor disk area. This thrust level is conservative, given that SRH experimental tests determined that the vehicle was capable of flying with adequate control authority at C_{T}/σ=0.15.

The rotor speed chosen is 2195 rpm, equal to a hover tip Mach number of 0.7. The initial target pitch angle chosen for the flight profile is chosen as

$${θ}_{t}^{0} = - 55 ° .$$

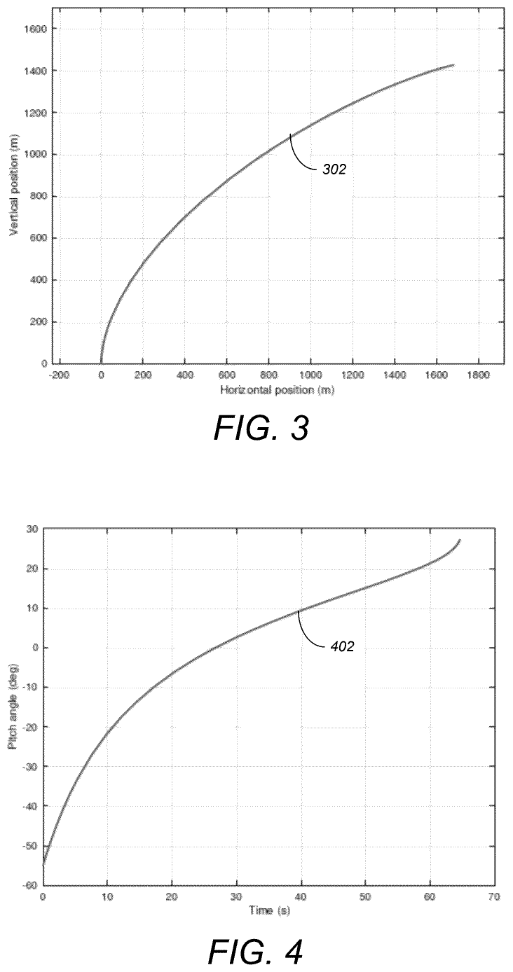

FIG. 3 shows the trajectory that would result from a perfect execution of the flight profile. The helicopter loses 1427m of altitude and travels 1684m horizontally. More specifically, curve 302 illustrates the position trajectory for a perfectly executed Skyfall flight profile. The helicopter's starting position is defined as the origin, and positive z is downward.

FIG. 4 shows the pitch angle as a function of time. Mor specifically, FIG. 4 illustrates pitch angle 402 for a perfectly executed Skyfall flight profile. Positive pitch angle is defined as nose-up.

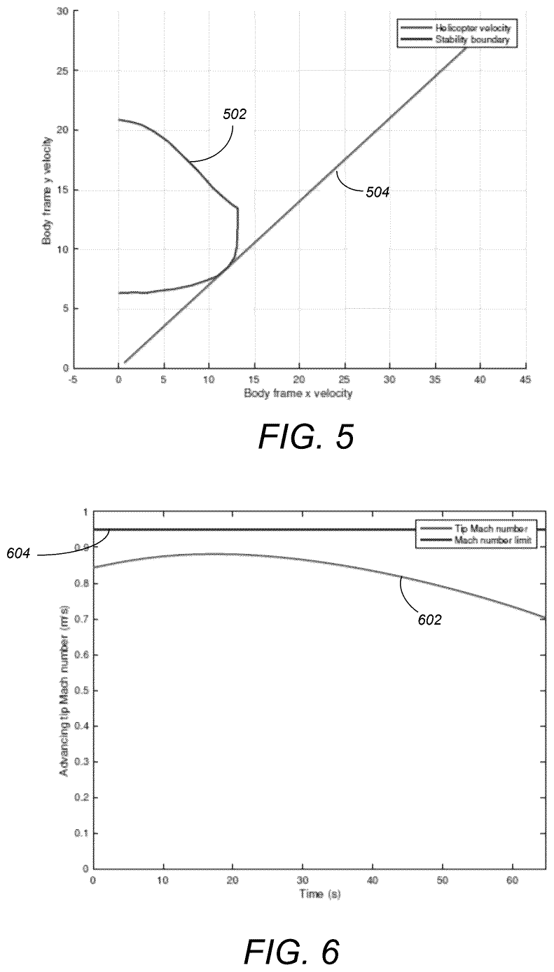

FIG. 5 shows the horizontal vs. vertical velocity in the body-fixed frame. Curve 502 in FIG. 5 marks the approximate vortex ring state stability boundary [7]. The profile is designed to barely skirt this region; depending on the desired level of conservatism, more margin can be added by enforcing a less-negative

$${θ}_{t}^{0}$$

or by locally modifying the flight profile in the relevant region. Curve 504 illustrates the perfectly executed flight profile while curve 502 illustrates the vortex ring state stability boundary from [7].

FIG. 6 shows the advancing tip Mach number throughout the flight profile, which starts at 0.84 and peaks at 0.88. More specifically, FIG. 6 illustrates the advancing tip Mach number 602 during a perfectly executed flight profile. The assumed tip Mach number limit is shown as curve 604.

This analysis shows that a perfectly executed flight profile is capable of both avoiding vortex ring state and exceeding the tip Mach number limits. There is approximately 16 m/s margin to the tip Mach number limit, which can be used to absorb errors. There are also design changes that can buy back margin; for example, a modest increase in rotor solidity has a significant effect on performance for the flight profile.

The following section addresses the issue of helicopter trim and control under the relevant flight conditions.

### Helicopter Trim

The first step toward controlling the helicopter is trimming it for the appropriate flight condition. To verify that this can be done for an Ingenuity/SRH (Sample-Recovery Helicopter) class helicopter, the DARTS-HeliCAT model used for development and operation of Ingenuity was used. The Ingenuity model was trimmed at a rotor speed of 2337 rpm at a density of 0.0155 kg/m³ and a thrust level consistent with C_{T}/σ=0.14, approximately consistent with the SRH model hypothesized in the previous analysis.

A dynamic inflow model was used for modeling of inflow [9]. Rotor interference was assumed negligible, since (i) it tends to diminish with greater forward flight velocities, as was observed in experiments with Ingenuity; and (ii) no validated model of rotor interference was available for this flight condition. Detailed interference modeling is needed for eventual higher-fidelity analysis.

With cyclic control on both rotors, the vehicle is over-actuated in roll and pitch, and the extra degrees of freedom can be used in different ways. Two methods were explored:
(1) Cyclics trimmed to minimize the roll and pitch torque from each rotor individually, while nulling the overall roll and pitch moment on the vehicle; and
(2) Cyclics trimmed to minimize the angle-of-attack difference between the advancing and retreating side while nulling the overall roll and pitch moment.

Both methods were found to be feasible but with different pros and cons: method (1) results earlier occurrence of retreating blade stall; method (2) may result in larger vibrations.

For the remaining discussion, method (1) is assumed. In the initial condition, immediately following a release at 39 m/s release velocity, the trim control settings were found to be:
Collective: −9.7° on both rotors
Cosine cyclic (peaking at rear of rotor disk): 1.2° on upper rotor and 0.8° on lower rotor
Sine cyclic (peaking on right-hand side of rotor disk): −0.6° on upper rotor and 0.6° on lower rotor

The cyclic values are well within the control range of Ingenuity, but the collective control range would need to be extended to support the low angles required, as Ingenuity's collective range extended only to −4.5°.

### Power During Aerial Delivery

The low collective required for trim is due to the net inflow through the rotor disk being highly negative, as a result of the fast descent rate. This is also reflected in the power: unlike a helicopter in normal flight, which must expend energy to power its rotors and stay aloft, the helicopter initially produces power, like a windmill, and must use its rotors to brake rather than propel the rotors.

In normal flight, the propulsion motor must compensate for two types of power: induced power is due to induced drag, which a portion of blade lift that acts horizontally rather than vertically, pulling the blade backward; profile power is due to profile drag, which is the force required to drag a body through a fluid. In an autorotating helicopter, the induced lift acts to pull the blade forward rather than backward, and in the specific case of the Skyfall flight profile, it is initially greater than the profile drag, resulting in negative energy consumption. The mechanical shaft power is approximately −35W compared to approximately +150 W during normal hover. As the helicopter executes the flight profile, the trim point gradually transitions to a power-consuming rather than a power-producing state.

### Helicopter Control

For the Ingenuity mission, the helicopter was controlled by variable blade pitch in a classical way for coaxial helicopters:
Combined collective was used to vary thrust level, for heave control.
Cyclics were used for roll and pitch control.
Differential collective was used for yaw control.

The reason that differential collective can be used for yaw control is that, by modulating the relative distribution of thrust between the two rotors, the torque required to compensate for drag on each rotor is modulated, with more torque required for higher thrust. This results in a torque differential between the rotors that is used for control. The rotor speeds for Ingenuity were controlled as follows:
Differential motor torque was used to maintain the desired average rotor speed.
The combined motor torque was used to maintain a zero differential rotor speed.

(Recall that positive motor torque is defined as acting about the vehicle z axis, whereas positive rotor speed is defined relative to the rotor's nominal direction of rotation; hence differential torque is mapped to the average rotor speed and combined motor torque is mapped to differential rotor speed.)

### Control Problem During Aerial Delivery

A particular problem arises when applying the classical Ingenuity control scheme to the aerial delivery, due to the helicopter's unusual power state. During the initial portion of the aerial delivery flight profile, the helicopter is producing power, and the more it thrusts, the more power it produces. In the latter portion of the flight, the helicopter is consuming power, and the more it thrusts, the more power it consumes. Somewhere along the continuum between these two conditions, the helicopter will pass through a point where producing more thrust has no effect on power. In particular, this occurs when the sensitivity of induced power to thrust is precisely offset by the sensitivity of profile power to thrust.

This is highly problematic for control, because rotor torque=power/rotor speed. Therefore, a lack of sensitivity in power implies a lack of sensitivity in rotor torque. Rotor torque is the means by which helicopter yaw is controlled; thus, the helicopter will first lose yaw control authority, and then the sign of the torques produced in response to the control inputs will flip. At this point, the classical control scheme will be destabilizing rather than stabilizing. Simulation confirms that the helicopter goes unstable at this point.

Abandoning yaw control during this phase of flight avoids actively destabilizing the helicopter, but results in rapid spinning of the helicopter body, which is unworkable in practice.

The same effect on yaw control is faced by Earth coaxial helicopter in autorotation, but can be compensated for large by aerodynamic surfaces on a tail boom, which maintains directional stability like a weather vane (see the full-scale Kamov Ka-52 coaxial helicopter). This solution scales extremely poorly on Mars due to the low atmospheric density, and is not feasible from a mass or volume perspective.

### Solution to the Control Problem

The solution to the control problem is found by re-assigning the way that control inputs are used for different control channels. In particular:
Like before, combined collective and cyclic are used for heave, roll, and pitch control.
Like before, differential motor torque is used to control average rotor speed.
Unlike before, combined motor torque is used to control yaw.
Unlike before, the differential collective is used to control differential rotor speed.

By itself, this does not solve the problem, but it moves the problematic loss of control and instability from the fuselage yaw axis to the differential rotor speed. To avoid a full-on instability due to the sign flip that occurs along the flight profile, control of the differential rotor speed is temporarily abandoned during this phase of flight. This results in divergence of the two rotor speeds, but unlike a spinning fuselage, this is a tolerable condition. Natural aerodynamic damping prevents runaway divergence of the differential rotor speed, and because the average rotor speed is still being maintained, the helicopter does not lose thrust. Because the phenomenon occurs well after peak airspeed, the divergence does not rise to the level where Mach number violations are a concern.

### Prototype Controllers

Control and stability derivatives were determined for the Ingenuity model at its trim point, and prototype controllers were developed for roll, pitch, yaw, and average/differential motor speeds. To maintain adequate thrust throughout the flight, the difference between desired and achieved vertical acceleration was fed back through a pure integral-type controller with a slow time constant.

### Simulation

The Ingenuity model was equipped with the prototype controller and execution of the flight profile was simulated under the atmospheric conditions stated earlier. Zero-mean wind was applied based on measurements from the Mars 2020 MEDA (Mars Environmental Dynamics Analyzer) instrument. Three primary simplifying assumptions were made:
(1) No navigation system was simulated; instead, linear and angular velocities, as well as linear velocities, were assumed known.
(2) The propulsion motors were modeled as direct torque-producing devices without back-EMF (electromagnetic fields). Back-EMF imposes a speed-dependent torque that can be canceled by using measurements of the rotor speed; thus, this is not considered a significant issue.
(3) As already mentioned above, no interference between the rotor inflow models was modeled. Capturing this effect is likely to be quantitatively significant and more accurate modeling is a high priority; however, the fundamental physical phenomenon of transitioning through a region with loss of control authority is captured even without accurate interference modeling.

To illustrate the feasibility of leaving the differential rotor speed uncontrolled, the controller is turned off throughout the entire flight, with no significant adverse effects observed.

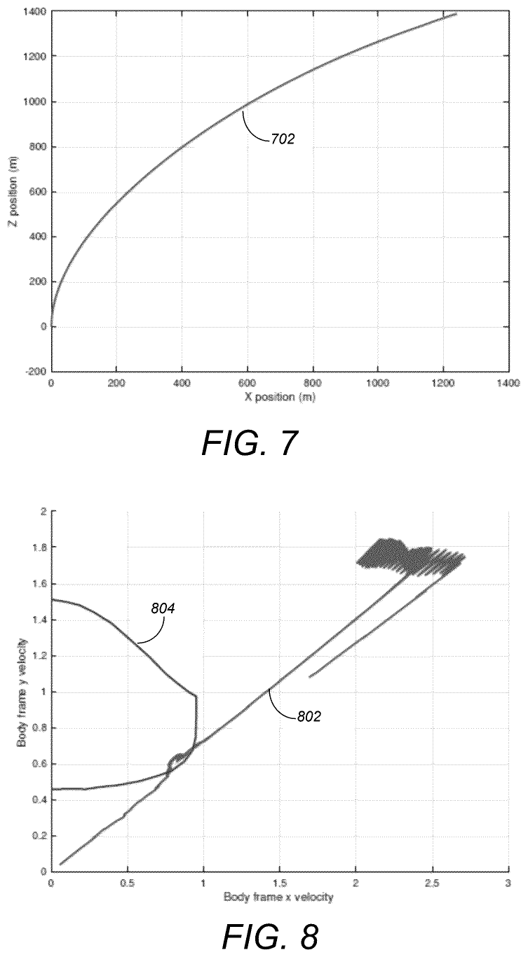

FIG. 7 shows the simulated trajectory, with loss of altitude of approximately 1400 m. More specifically, FIG. 7 illustrates the position trajectory 702 for simulated execution of a controlled Skyfall flight profile in DARTS-HeliCAT. The helicopter's starting position is defined as the origin, and positive z is downward.

Horizontal vs. vertical velocity is shown in FIG. 8, normalized by the hover induced velocity at the current instantaneous thrust level. The hover induced velocity was computed as though both rotors were collapsed into a single rotor disk. In this particular case, that assumption is conservative; considering the rotors separate would yield greater margin against the vortex ring state boundary. This shows a minor excursion within the vortex ring state stability boundary from [7]. This is not necessarily a problem, and margin against this can be added with a local fine-tuning of the flight profile. More specifically, FIG. 8 illustrates curve 802 that reflects horizontal velocity vs. vertical velocity for the controlled Skyfall flight profile in DARTS-HeliCAT, normalized by the hover induced velocity at the instantaneous thrust level. The approximate vortex ring state stability boundary is shown as curve 804 [7].

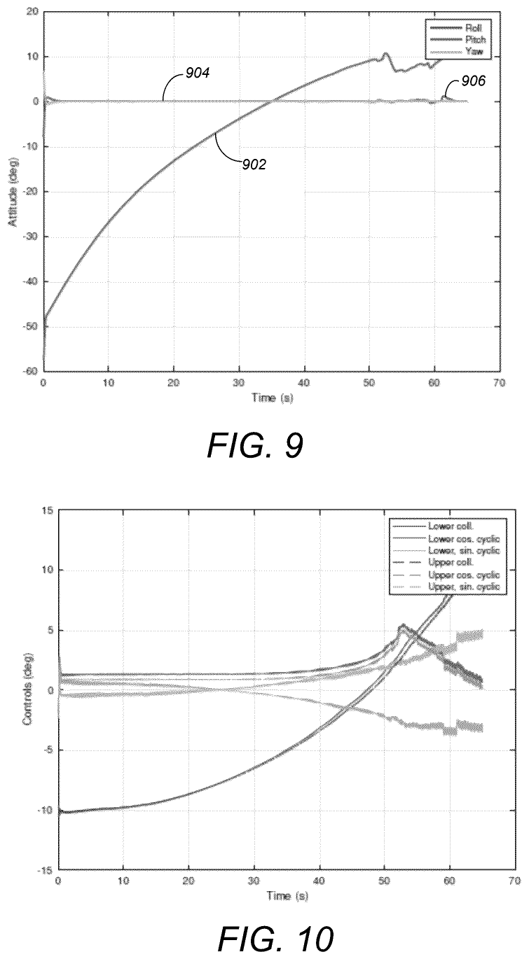

Simulated attitude is shown in FIG. 9. More specifically, FIG. 9 illustrates the attitude for the controlled Skyfall flight profiled in DARTS-HeliCAT with curve 902 for the pitch, curve 904 for the yaw, and curve 906 for the roll. Although some unsteadiness can be observed toward the end of the profile, the helicopter remains stable.

Collective and cyclic control inputs can be seen in FIG. 10. In particular, FIG. 10 illustrates collective and cyclic control inputs for the controlled Skyfall flight profile in DARTS-HeliCAT with different curves for the different inputs including lower collective, cosine cyclic, lower sine cyclic, upper collective, upper cosine cyclic, and upper sine cyclic.

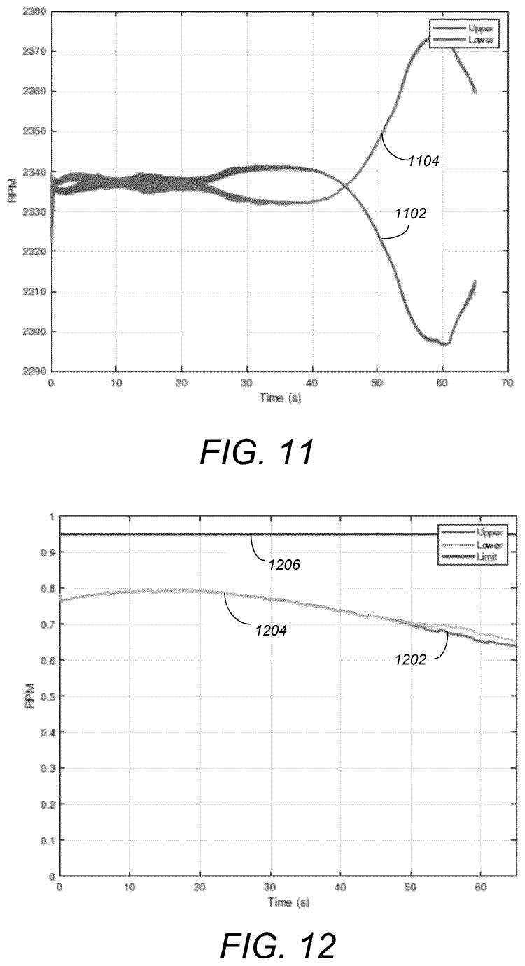

The result of turning off differential RPM control can be observed in FIG. 11. The region of temporary rapid divergence corresponds to the point along the flight profile where control authority is lost and vehicle instability would have been experienced using the traditional control scheme. More specifically, FIG. 11 illustrates upper 1102 and lower 1104 rotor speeds for controlled Skyfall flight profile in DARTS-HeliCAT.

The simulated Mach number at the advancing tip (for controlled Skyfall flight profile in DARTS-HeliCAT) is shown in FIG. 12, showing ample margin that can be traded against margin in other areas (e.g., against the vortex ring state boundary). In FIG. 12, curve 1202 represents the upper advancing tip Mach number, curve 1204 represents the lower advancing tip Mach number, and curve 1206 represents the limit for the advancing tip Mach number.

Note that the results cannot be compared one-to-one with the results for perfect control as described above, since those were produced assuming an SRH-like vehicle rather than Ingenuity.

### Logical Flow

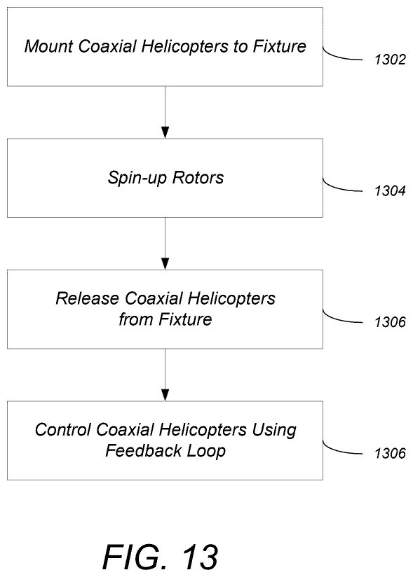

FIG. 13 illustrates the logical flow for direct mid-air coaxial helicopter delivery in accordance with one or more embodiments of the invention.

At step 1302, one or more coaxial helicopters are mounted to a fixture attached to a descending parachute. The one or more coaxial helicopters have two rotors mounted coaxially that are independently actuated. In one or more embodiments, the one or more coaxial helicopters are mounted in a nose-down orientation with a defined target pitch angle for initial flight. The target pitch angle

$${θ}_{t}^{0}$$

is chosen such that for any scalar, a, a body-fixed air-relative velocity of

$${w}^{b} = a [ - sin ( {θ}_{t}^{0} ) , 0 , cos ( {θ}_{t}^{0} ) ]$$

is outside of an aerodynamic region for which the one or more coaxial helicopters would encounter a vortex ring state.

At step 1304, the two rotors of the one or more coaxial helicopters are spun-up to a constant operating speed (e.g., using a rotor mechanism).

At step 1306, each of the one or more coaxial helicopters are released from the fixture (e.g., using a release mechanism). In one or more embodiments, the releasing is performed at a pre-determined target altitude above ground.

At step 1308, after the releasing, the one or more coaxial helicopters are controlled (e.g., via a control system in the helicopters) using a feedback loop. In particular, the roll and pitch are controlled by feeding back a roll and pitch angle error to a combination of collective and cyclic blade pitch controls to produce roll and pitch torques. The heading is controlled by feeding back yaw angle error to a combined motor torque of the two rotors. Further, the rotor speed of each of the two rotors is controlled by feeding back a scalar combination of rotor speed errors to a differential motor torque of the two rotors (wherein the rotor speed errors comprise a difference between a measured rotor speed and a target rotor speed).

In one or more embodiments, each of the one or more coaxial helicopters may be controlled by setting:
(a) a thrust at a minimum predefined percentage above vehicle weight;
(b) a roll angle to maintain a maximum predefined level;
(c) a pitch angle to within a predefined range relative to the angle of an estimated current air relative velocity vector of the helicopter relative to a horizontal; in which the current air relative velocity vector can either be sensed directly or estimated. One such estimated current air relative velocity vector can be obtained by measuring or estimating ground-relative velocity and subtracting the horizontal component from the initial horizontal component prior to release. The horizontal airspeed prior to release is expected to be near-zero, due to the tendency of a parachute to catch up with the wind. Alternatively, pitch angle can be controlled to a time-dependent target pitch angle θₜ(t) that was determined based on an offline simulation of the maneuver under nominal conditions.
(d) a heading within a range relative to an initial release heading; and
(e) an average rotor speed controlled to within a range of a chosen target rotor speed.

In additional embodiments, a differential rotor speed may be controlled by feeding back a differential rotor speed to a differential collective. In such embodiments, the differential rotor speed is a difference between the rotor speeds of the two rotors; a positive rotor speed is defined as rotation in a nominal direction of rotation of each rotor; and a differential collective is defined as a difference between collective pitch angles of the two rotors.

Further to the above, the controlling step 1306 may be performed for a part of a maneuver of one or more of the one or more coaxial helicopters. For example, at a pre-determined time during a flight profile, control of the differential rotor speed may be disabled. In such embodiments, the predetermined time is prior to a loss of control authority in a channel resulting from a transition from flight with negative power to a flight with positive power. Thereafter, in additional embodiments, after a second pre-determined interval, control of the differential rotor speed is re-enabled with a different set of controller gains. Such a second predetermined interval is after control authority in the channel is re-established.

After leveling out in flight, the control system may enable the one or more coaxial helicopters to transition to a full six (6) degrees of freedom control (e.g., using convention control mechanisms).

In addition to the above, thrust (of each of the helicopters) may be controlled by feeding back vertical acceleration error to a combination of collective and cyclic blade pitch control to produce a change in thrust.

### Conclusion

This concludes the description of the preferred embodiment of the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

[1] J. Balaram, T. Canham, C. Duncan, M. Golombek, H. F. Grip, J. Maki, A. Quon, R. Stern, and D. Zhu. Mars Helicopter technology demonstrator. In Proc. AIAA Atmospheric Flight Mechanics Conference, 2017.
[2] J. Delaune, J. Izraelevitz, L. Young, W. Rapin, E. Sklyanskiy, W. Johnson, A. Schutte, A. Fraeman, V. Scott, C. Leake, E. Ballesteros, S. Withrowand R. Bhagwat, H. Cummings, K. Aaron, M. Veismann, S. Wei, R. Lee, L. Pabon Madrid, M. Gharib, and J. Burdick. Motivations and preliminary design for mid-air deployment of a science rotorcraft on Mars. In AIAA ASCEND Conf., 2020.
[3] Jeff Delaune, Jacob Izraelevitz, Samuel Sirlin, David Sternberg, Louis Giersch, L. Phillipe Tosi, Evgeniy Skliyanskiy, Larry Young, Michael Mischna, Shannah Withrow-Maser, Juergen Mueller, Joshua Bowman, Mark S Wallace, Havard F. Grip, Larry Matthies, Wayne Johnson, Matthew Keennon, Benjamin Pipenberg, Harsh Patel, Christopher Lim, Aaron Schutte, Marcel Veismann, Haley Cummings, Sarah Conley, Jonathan Bapst, Theodore Tzanetos, Roland Brockers, Abhinandan Jain, David Bayard, Art Chmielewski, Olivier Toupet, Joel Burdick, Morteza Gharib, and J. Balaram. Mid-air helicopter delivery at Mars using a jetpack. In IEEE Aerospace Conf., 2022.
[4] Ralph D. Lorenz, Elizabeth P. Turtle, Jason W. Barnesand Melissa G. Trainer, Douglas S. Adams, Kenneth E. Hibbard, Colin Z. Sheldon, Kris Zacny, Patrick N. Peplowski, David J. Lawrence, Michael A. Ravine, Timothy G. McGee, Kristin S. Sotzen, Shannon M. Mackenzie, Jack W. Langelaan, Sven Schmitz, Lawrence S. Wolfarth, and Peter D. Bedini. Dragonfly: A rotorcraft lander concept for scientific exploration at Titan. Johns Hopkins APL Technical Digest, 34(3), 2018.
[5] A. Pensado, R. G. Winski, J. W. Williams, and C. Robb. Dragonfly mission entry and descent modeling and simulation overview. In Proc. AIAA Scitech Forum, Orlando, FL, 2025.
[6] Carl Leake, Håvard Grip, Vivian Steyert, Tristan D. Hasseler, Martin Cacan, and Abhinandan Jain. Helicat-darts: A high fidelity, closed-loop rotorcraft simulator for planetary exploration. Aerospace, 11(9), 2024.
[7] W. Johnson. Model for vortex ring state influence on rotorcraft flight dynamics. Technical report NASA/TP-2005-213477, NASA Ames Research Center, 2005.
[8] Fernando Mier-Hicks, Håvard Fjær Grip, Arash Kalantari, Scott J. Moreland, Benjamin Pipenberg, Matthew Keennon, Timothy K. Canham, Michael T. Pauken, Emmanuel Decrossas, Theodore Tzanetos, and J. Balaram. Sample Recovery Helicopter. In Proc. IEEE Aerospace Conference, Big Sky, MT, 2023.
[9] D. A. Peters and N. HaQuang. Dynamic inflow for practical applications. J. American Helicopter Society, 33(4):64-68, 1988.

What is claimed is:

1. A method for direct mid-air coaxial helicopter delivery comprising:
(a) mounting one or more coaxial helicopters to a fixture attached to a descending parachute, wherein the one or more coaxial helicopters comprise two rotors mounted coaxially that are independently actuated;
(b) spinning up the two rotors of the one or more coaxial helicopters to a constant operating speed;
(c) releasing each of the one or more coaxial helicopters from the fixture;
(d) after the releasing, controlling the one or more coaxial helicopters using a feedback loop by:
(i) controlling roll and pitch by feeding back a roll and pitch angle error to a combination of collective and cyclic blade pitch controls to produce roll and pitch torques;
(ii) controlling heading by feeding back yaw angle error to a combined motor torque of the two rotors; and
(iii) controlling a rotor speed of each of the two rotors by feeding back a scalar combination of rotor speed errors to a differential motor torque of the two rotors, wherein the rotor speed errors comprise a difference between a measured rotor speed and a target rotor speed, and wherein the differential motor torque comprises a difference between motor torques of the two rotors.

2. The method of claim 1, wherein:
the one or more coaxial helicopters are mounted in a nose-down orientation; and
the one or more coaxial helicopters are mounted with a defined target pitch angle for initial flight.

3. The method of claim 2, wherein:
the target pitch angle
$${θ}_{t}^{0}$$
is chosen such that:
for any scalar, a, a body-fixed air-relative velocity of
$${w}^{b} = a [ - sin ( {θ}_{t}^{0} ) , 0 , cos ( {θ}_{t}^{0} ) ]$$
is outside of an aerodynamic region for which the one or more coaxial helicopters would encounter a vortex ring state.

4. The method of claim 1, wherein:
the releasing is performed at a pre-determined target altitude above ground.

5. The method of claim 1, wherein each of the one or more coaxial helicopters is controlled by setting:
(a) a thrust at a minimum predefined percentage above vehicle weight;
(b) a roll angle to maintain a maximum predefined level;
(c) a pitch angle to within a predefined range relative to an angle of an estimated air relative velocity vector of the coaxial helicopter relative to a horizontal;
(d) a heading within a range relative to an initial release heading; and
(e) an average rotor speed controlled to within a range of a chosen target rotor speed.

6. The method of claim 1, wherein each of the one or more coaxial helicopters is controlled by setting:
(a) a thrust at a minimum predefined percentage above vehicle weight;
(b) a roll angle to maintain a maximum predefined level;
(c) a pitch angle to within a time-dependent target pitch angle that was determined based on an offline simulation of a maneuver;
(d) a heading within a range relative to an initial release heading; and
(e) an average rotor speed controlled to within a range of a chosen target rotor speed.

7. The method of claim 1, wherein the controlling the one or more coaxial helicopters using a feedback loop further:
(f) controls a differential rotor speed by feeding back a differential rotor speed to a differential collective, wherein:
the differential rotor speed comprises a difference between the rotor speeds of the two rotors;
a positive rotor speed is defined as rotation in a nominal direction of rotation of at least one of the two rotors; and
a differential collective is defined as a difference between collective pitch angles of the two rotors.

8. The method of claim 1, wherein the controlling is performed for a part of a maneuver of one or more of the one or more coaxial helicopters.

9. The method of claim 1, further comprising:
at least one of the one or more coaxial helicopters leveling out in flight;
transitioning to a full six (6) degrees of freedom control.

10. The method of claim 1, wherein the controlling controls thrust by feeding back vertical acceleration error to a combination of collective and cyclic blade pitch control to produce a change in thrust.

11. A coaxial helicopter comprising:
(a) the coaxial helicopter mounted to a fixture attached to a descending parachute, wherein the coaxial helicopter comprises two rotors mounted coaxially that are independently actuated;
(b) a rotor mechanism spinning up the two rotors to a constant operating speed;
(c) a release mechanism that releases the coaxial helicopter from the fixture;
(d) a control system of the coaxial helicopter, wherein after the releasing, the control system controls the coaxial helicopter using a feedback loop by:
(i) controlling roll and pitch by feeding back a roll and pitch angle error to a combination of collective and cyclic blade pitch controls to produce roll and pitch torques;
(ii) controlling heading by feeding back yaw angle error to a combined motor torque of the two rotors; and
(iii) controlling a rotor speed of each of the two rotors by feeding back a scalar combination of rotor speed errors to a differential motor torque of the two rotors, wherein the rotor speed errors comprise a difference between a measured rotor speed and a target rotor speed, and wherein the differential motor torque comprises a difference between motor torques of the two rotors.

12. The coaxial helicopter of claim 11, wherein:
the coaxial helicopter is mounted to the fixture in a nose-down orientation; and
the coaxial helicopter is mounted with a defined target pitch angle for initial flight.

13. The coaxial helicopter of claim 12, wherein:
the target pitch angle
$${θ}_{t}^{0}$$
is chosen such that:
for any scalar, a, a body-fixed air-relative velocity of
$${w}^{b} = a [ - sin ( {θ}_{t}^{0} ) , 0 , cos ( {θ}_{t}^{0} ) ]$$
is outside of an aerodynamic region for which the coaxial helicopter would encounter a vortex ring state.

14. The coaxial helicopter of claim 11, wherein:
the releasing is performed at a pre-determined target altitude above ground.

15. The coaxial helicopter of claim 11, wherein the coaxial helicopter is controlled by setting:
(a) a thrust at a minimum predefined percentage above vehicle weight;
(b) a roll angle to maintain a maximum predefined level;
(c) a pitch angle to within a predefined range relative to an angle of an estimated air relative velocity vector of the coaxial helicopter relative to a horizontal plane;
(d) a heading within a range relative to an initial release heading; and
(e) an average rotor speed controlled to within a range of a chosen target rotor speed.

16. The coaxial helicopter of claim 11, wherein the coaxial helicopter is controlled by setting:
(a) a thrust at a minimum predefined percentage above vehicle weight;
(b) a roll angle to maintain a maximum predefined level;
(c) a pitch angle to within a time-dependent target pitch angle that was determined based on an offline simulation of a maneuver;
(d) a heading within a range relative to an initial release heading; and
(e) an average rotor speed controlled to within a range of a chosen target rotor speed.

17. The coaxial helicopter of claim 11, wherein the controlling using the feedback loop further:
(f) controls a differential rotor speed by feeding back a differential rotor speed to a differential collective, wherein:
the differential rotor speed comprises a difference between the rotor speeds of the two rotors;
a positive rotor speed is defined as rotation in a nominal direction of rotation of at least one of the two rotors; and
a differential collective is defined as a difference between collective pitch angles of the two rotors.

18. The coaxial helicopter of claim 11, wherein the controlling is performed for a part of a maneuver of the coaxial helicopter.

19. The coaxial helicopter of claim 11, wherein the control system further:
levels the coaxial helicopter out in flight;
transitions to a full six (6) degrees of freedom control.

20. The coaxial helicopter of claim 11, wherein the controlling is performed by controlling thrust by feeding back vertical acceleration error to a combination of collective and cyclic blade pitch control to produce a change in thrust.
